(19) United States
(12) Patent Application Publication
(10) Pub. No.: US 2004/0213580 A1
(43) Pub. Date: Oct. 28, 2004

(54) Transmitter and a signal generator in optical transmission systems

(75) Inventors: Toru Masuda, Kodaira (JP); Kenichi Ohhata, Hachioji (JP); Nobuhiro Shiramizu, Kokubunji (JP); Eiji Ohue, Kumagaya (JP); Katsuyoshi Washio, Tokorozawa (JP)

Correspondence Address: MILES & STOCKBRIDGE PC, 1751 PINNACLE DRIVE, SUITE 500, MCLEAN, VA, 22102-3833, US

(73) Assignees: Hitachi, Ltd.; Hitachi Device Engineering Co., Ltd.

(21) Appl. No.: 10/300,789

(22) Filed: Nov. 21, 2002

(30) Foreign Application Priority Data
Jan. 18, 2002 (JP) P2002-009565

(51) Int. Cl. H04J 14/08; H04B 10/04

(52) U.S. Cl. 398/183

(57) ABSTRACT

The present invention provides an optical transmitter using a multiplexer which can maintain a timing margin between a clock and data as an operating reference at an optimal value when data transmission speed, or data rate to be handled is changed.

A delay circuit is arranged in a clock path in the multiplexer. A trigger of an operating clock of a frequency divider and a trigger of a delayed flip-flop or a multiplexer block are inverted so that a data margin is in proportion to the data transmission speed.

When the data transmission speed is changed, the multiplexer can optimize the timing margin of the delayed flip-flop or the multiplexer block by non-adjustment. The optical transmitter can be operated normally when the operating speed is changed widely.

### BACKGROUND OF THE INVENTION

1. Field of the Invention

The present invention relates to a transmitter and a signal generator in optical transmission systems having a multiplexer converting parallel data into serial data.

2. Description of the Related Art

In recent years, to increase capacity in data transmission systems, increase in data transmission speed has been strongly desired in a back-bone network such as optical fiber communication. An optical transmission system needs an optical transmitter and an optical receiver which can be operated at high speed. Since a time per data one-period is decreased with the increase in data transmission speed, a circuit constructing an optical transmitter and an optical receiver reduces a tolerant margin for wanted operation because the influence of a timing shift due to process deviation during manufacture and temperature deviation in an operating environment becomes large. A multiplexer and a demultiplexer subject an input or output signal to synchronize securement and waveform reshaping by a clock.

Using the most basic delayed flip-flop shown in FIG. 2A, the relation between a clock and data will be described with FIG. 2B.

The delayed flip-flop (D-FF) decides data to an INPUT end by referring to the rising edge in a CLOCK and sends the data in synchronization with the CLOCK from an OUTPUT end to the next stage.

In order for the delayed flip-flop to obtain constantly correct data, the timing of the rising edge in the CLOCK must be shifted from the data switching timing. FIG. 2B is an operating waveform chart. Data 1 and 2 shown in FIG. 2B show examples in which there is data switching in the timing of the rising edge in the CLOCK. In this case, an error occurs in the output of the delayed flip-flop. An example having the fewest errors is Data 3. The data is decided at preferable timing without data switching in a setup period Tsetup prior to the rising edge in the CLOCK and a hold period Thold thereafter.

The optimal data sampling timing in the delayed flip-flop is such that the CLOCK rises in a data one-period. In other words, an optimal value of data margin Tm to data one-period T is T/2.

In an optical transmitter, in a multiplexer operation sequentially multiplexing a plurality of parallel low-speed signals to convert them into one high-speed signal, high-speed signal synchronizing between data and clocks is essential. With the increase in data transmission speed, as described above, there is no difference in magnitude between the data one-period and the timing shift caused by process deviation during manufacture and temperature deviation in an operating environment. A robust design operated reliably under the influence of such deviations has been difficult.

A signal generator of a high-speed arbitrary pattern is necessary as an evaluating device for the optical transmission system. The signal generator must multiplex a plurality of parallel low-speed signals to generate a high-speed arbitrary pattern. As in the optical transmitter, the multiplexer operation is necessary. The evaluating device, which requires general versatility, must generate a signal having wide data transmission speed.

It is necessary to prevent malfunction caused by process, temperature, and data period deviations.

A prior art reducing such influence due to process deviation and temperature deviation in a multiplexer to enhance the operating stability is disclosed in Japanese Published Unexamined Patent Application No. Hei 9-55667. FIG. 3 shows a circuit block diagram of the prior art.

In the prior art, a first stage is made up of 2:1 multiplexers 101, 102 receiving, as a clock input, a 1/4 CLK generated by dividing a high-speed clock CLK by two 1:2 frequency dividers 105 and 105a and converting parallel data 0-3 into serial data; a second stage is made up of a 2:1 multiplexer 103 receiving, as a clock input, a 1/2 CLK generated by dividing the high-speed clock CLK by the 1:2 frequency divider 105; and a final output stage is made up of a multiplexer having a retiming use delayed flip-flop 104 using the high-speed clock CLK as a clock input. The delayed flip-flop 104 is provided on its data input side with a variable delay circuit 110 connected to a control circuit 130 for delay adjustment and on its data output side with a waveform monitor 120 monitoring the data signal.

The 4:1 multiplexer shown in FIG. 3 has two multiplexers 101, 102 at the first stage and one multiplexer 103 at the second stage. The delayed flip-flop 104 is arranged at the final stage. The part whose operating speed is highest in the block construction is the delayed flip-flop at the final stage. Data decision at optimal timing is important. The prior art inserts the variable delay circuit 110 into a data path to adjust the phase of data given to the delayed flip-flop 104, thereby preventing malfunction.

### SUMMARY OF THE INVENTION

To understand the operation of the prior art, the timing margin Tm is calculated from the timing chart shown in FIG. 4.

The 1:2 frequency divider 105 divides the high-speed clock input CLK by adding a delay of ΔTa. That is, the 1/2 CLK is generated.

When the divided clock-signal rises, the 2:1 multiplexer 103 adds a delay of ΔTd to output serial data SIG1. The variable delay circuit 110 adds a controllable delay of ΔT to output serial data SIG2 to the delayed flip-flop. The delay of the sum of ΔTa, ΔTb and ΔT is produced until data appears in the output of the variable delay circuit 110 from the high-speed clock input CLK.

The high-speed clock input CLK of the delayed flip-flop is inputted as-is. To sample the serial data SIG2, the high-speed clock CLK is pre-sent by n period to subject the serial data SIG2 to retiming.

Focusing on the serial data STG2, a time at which the clock CLK obtains rising edge data from data switching, that is, the timing margin is Tm. The following equation (1) is established from FIG. 4.

Tm=T×n−ΔTa−ΔTb−ΔT (1)

where n is the number of skipped period in high-speed “CLK” and n=3 in the shown example.

When ΔT=0 picoseconds (psec), ΔTa=5 psec, ΔTb=20 psec, Tp=25 psec and n=2, Tm=8 psec. Since T=25 psec, the delayed flip-flop obtains data at a time shifted from the center (12.5 psec) of the data one-period T. In the prior art, from n=3 and ΔT=17.5 psec, Tm=12.5 psec. The value is half of T=25 ps, which can obtain data at ideal timing because the variable delay circuit 110 which can set the arbitrary delay ΔT is introduced.

The prior art has the following two problems. One is that setting of the delay ΔT of the variable delay circuit 110 is not performed automatically or by non-adjustment during actual use, but a test pattern is inputted to monitor an output so that the delay is adjusted using the control circuit 130 for delay adjustment connected to the variable delay circuit. The process and temperature deviations can be coped with, but adjustment thereof is troublesome for practical use. The other is that the data transmission speed deviation cannot be coped with. The optimal timing margin Tm is obtained at the data period Tp=25 psec, that is, at a data transmission speed of 40 Gb/s. When the data period T is a variable in this state, the timing margin Tm is expressed by the following equation (2).

Tm=T×3−25 psec−20 psec−17.5 psec (2)

Using the equation (2), the data transmission speed dependence of the timing margin Tm is calculated to obtain the relation between the data transmission speed and the timing margin shown in FIG. 5. In FIG. 5, the multiplexer of the present invention is indicated by the characteristic line a and the multiplexer of the prior art is indicated by the characteristic line b. Both are set to an optimal margin at 40 Gb/s. The characteristic line c of the dotted line indicates the data one-period T.

Focusing on the characteristic line b of the prior art, the timing margin Tm in the range within from 0 psec to the data one-period is from 32 to 48 Gb/s at the center of 40 Gb/s as the design center. It is a range B of usable data transmission speed in the prior art. The equation (2) has the term depending on the period T and the sum of fixed values.

When the timing margin Tm completely depends on the data period T, as indicated by the characteristic line a, wide data transmission speed can be coped with. The usable data transmission speed can be provided as in a usable range A of the multiplexer of the present invention. The multiplexer of the present invention will be described in the later-described embodiments.

As described above, in the prior art, prior to actual use, it is essential to judge, by the waveform monitor, whether serial data appearing in an output by inputting predetermined parallel data is right or wrong and to adjust a variable delay via the control circuit for delay adjustment so as to output the serial data correctly. Such pre-adjustment is necessary. An optimal delay realized in the variable delay circuit is decided uniquely to one data transmission speed. When the input data transmission speed of the multiplexer is changed, the variable delay must be adjusted again.

Accordingly, an object of the present invention is to provide a transmitter and a signal generator in optical transmission systems using a multiplexer which can optimize the timing margin between a clock and data as an operating reference by non-adjustment when data transmission speed is changed.

An example of representative means of the present invention will be shown as follows. An optical transmitter having: a multiplexer receiving, as inputs, a plurality of parallel data and clock signals and multiplexing the parallel data to serial data; a laser driver amplifying the serial data; a laser generator generating an optical signal; a modulator outputting a modulated optical signal obtained by modulating the optical signal according to the modulated signal of the output of the laser driver; and an optical fiber transmitting the modulated optical signal,

wherein

the multiplexer has, at the nth stage (n is a natural number of 2 or above) as a final output stage, a clock buffer with a designed delay-time; and a retiming use delayed flip-flop receiving, as an input, one serial data from n−1th stage and outputting are serial data synchronized with a clock input via the clock buffer,

the multiplexer has, at the jth stage (j=1, . . . , n−1: j is a natural number), a frequency divider dividing a clock signal inputted to the jth stage; a clock buffer receiving, as an input, a divided clock-signal obtained by the frequency divider; and 2ⁿ⁻ⁿ⁻¹ multiplexer blocks converting two inputted parallel data into one serial data using the output clock of the clock buffer,

the jth stage 2^{n-j-1} multiplexer blocks are connected so that one serial data outputted from the multiplexer blocks is multiplexed to one serial data in the output of the n−1th stage multiplexer block,

the delay of the nth stage clock buffer with a designed delay-time is set to be the total of delays from the clock input of the n−1th stage frequency divider to the serial data output in the n−1th stage multiplexer block,

a clock signal of an operating reference of said n−1th stage frequency divider and a clock signal in which the nth stage delayed flip flop performs data decision are set to have a half period delay,

a delay produced in at least one of the second to jth stage clock buffer circuits is set to be the total of delays from the clock input of the j-1th stage frequency divider to the serial data output in the j-1th stage multiplexer block,

a clock signal of the operating reference of said j-1th stage frequency divider and a clock signal in which the jth-stage multiplexer block performs input data decision are set to have a half period delay.

The multiplexer used in the optical transmitter according to the present invention has a circuit construction in which the clock buffer with a designed delay-time which has not been used is introduced and the clock timing of the frequency divider and the delayed flip-flop is shifted by a clock half period. When the data transmission speed is changed, the timing margin of the delayed flip-flop at the final stage can be optimized by non-adjustment. The optical transmitter and the signal generator of the present invention using the multiplexer can be operated normally when the operating speed is changed widely.

The above and other objects of the present invention will be apparent from the following detailed description and the attached claims with reference to the accompanying drawings.

### BRIEF DESCRIPTION OF THE DRAWINGS

FIG. 1 is a circuit block diagram of an optical transmitter using a multiplexer showing a first embodiment of the present invention;

FIG. 2A is a delayed flip-flop;

FIG. 2B is an operating waveform chart of the delayed flip-flop;

FIG. 3 is a circuit block diagram showing a prior art of a multiplexer;

FIG. 4 is a diagram showing a timing chart of the prior art shown in FIG. 3;

FIG. 5 is a characteristic line diagram showing the relation between the data transmission speed and the timing margin of the multiplexers of the present invention and the prior art;

FIG. 6 is a diagram showing the timing chart of the multiplexer used in the optical transmitter and the signal generator of the present invention;

FIG. 7 is a circuit block diagram of the signal generator using a multiplexer showing a second embodiment of the present invention;

FIG. 8 is a circuit block diagram of another optical transmitter showing a third embodiment of the present invention;

FIG. 9 is a circuit block diagram showing a construction example of multiplexer blocks constructing the multiplexer used in the first to third embodiments;

FIG. 10 is a circuit block diagram showing another construction example of multiplexer blocks constructing the multiplexer used in the first to third embodiments;

FIG. 11 is a block diagram showing a construction example of a clock buffer with a designed delay-time constructing the multiplexer used in the first to third embodiments;

FIG. 12A is a circuit diagram of an essential part of a 1:2 frequency divider constructing the clock buffer with a designed delay-time of FIG. 11;

FIG. 12B is a circuit diagram of an essential part showing a construction example of a dummy delay-circuit corresponding to the 1:2 frequency divider of FIG. 12A;

FIG. 13A is a circuit diagram of an essential part showing a selector circuit constructing the clock buffer with a designed delay-time of FIG. 11; and

FIG. 13B is a diagram showing a construction example of a dummy delay-circuit corresponding to the selector circuit of FIG. 13A.

### DETAILED DESCRIPTION OF THE PREFERRED EMBODIMENTS

Preferred embodiments of the present invention will be described below in detail with reference to the accompanying drawings.

<Embodiment 1>

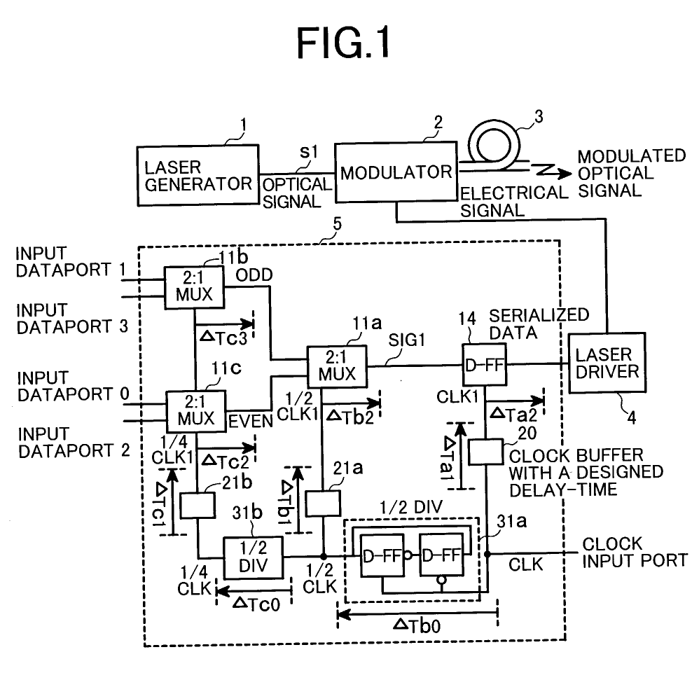

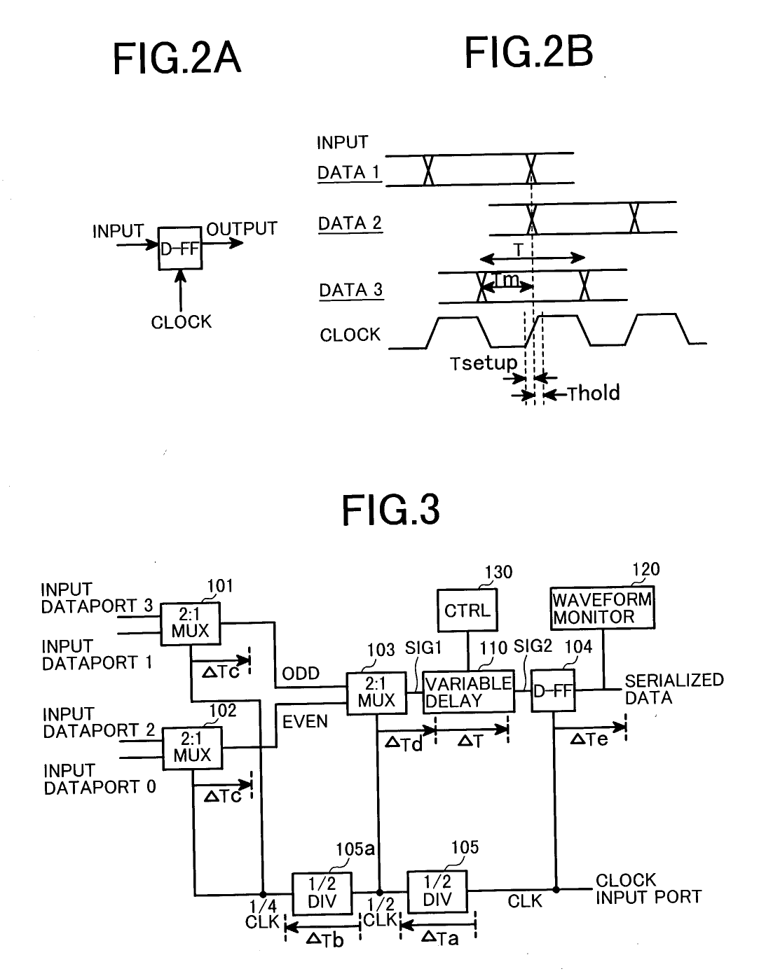

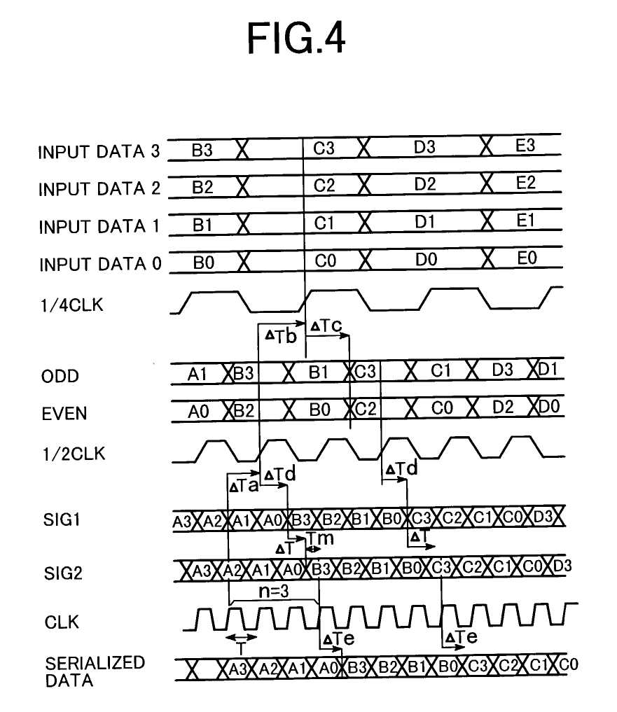

FIG. 1 is a circuit block diagram of an optical transmitter using a multiplexer showing a first embodiment of the present invention.

An optical transmitter shown in FIG. 1 has a multiplexer 5 receiving, as inputs, four parallel data 0-3 and multiplexing and outputting serial data; a laser driver 4 amplifying the output signal and supplying it to a laser modulator 2; and a laser generator 1 generating an optical signal s1 inputted to the laser modulator 2. The output of the laser modulator is transmitted to the next stage via an optical fiber 3.

The multiplexer 5 is divided into the first to the third stages. The first stage has two multiplexer blocks (2:1 MUX) 11b, 11c multiplexing the four parallel data 0-3 to two parallel data; a clock buffer 21b; and a 1:2 frequency divider 31b superposing frequency division to the input of the high-speed clock CLK to output a 1/4 divided clock-signal.

The second stage has one multiplexer block 11a multiplexing the two parallel data of the output of the first stage to one serial data; a clock buffer 21a; and a 1:2 frequency divider 31a dividing the high-speed clock input.

The third stage as the final stage has a delayed flip-flop 14 performing retiming of the serial data of the output of the second stage; and a clock buffer 20 with a designed delay-time supplying the high-speed clock CLK to the delayed flip-flop.

In the block construction, the 1:2 frequency divider 31a changes the output signal, that is, the input signal of the clock buffer 21a at the rise edge in the high-speed clock input CLK. The delayed flip-flop 14 is connected so as to decide and sample data at the fall edge in the clock of the output of the clock buffer 20 with a designed delay-time. A delay ΔTa1 of the clock buffer 20 with a designed delay-time is set to a time from the high-speed clock input to the data output of the multiplexer block 11a, that is, ΔTb0+ΔTb1+ΔTb2.

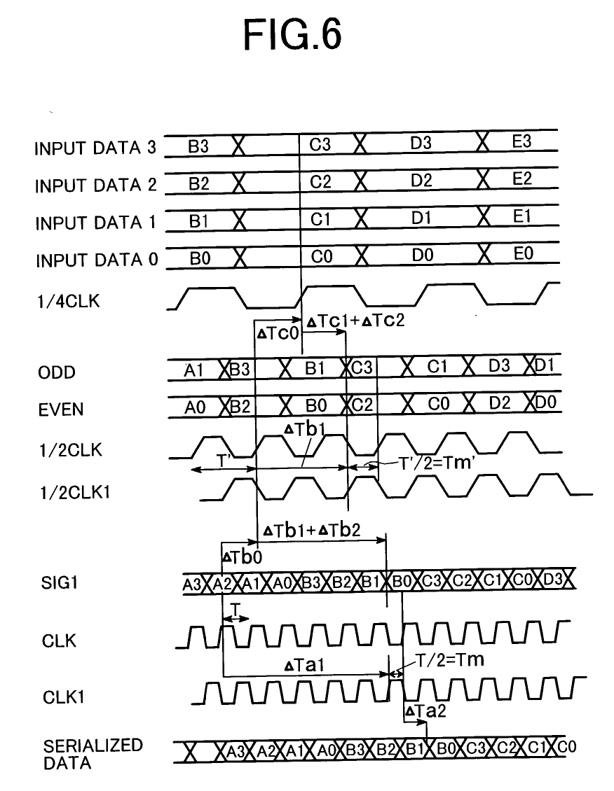

The effect obtained by providing the above connection and delay requirements will be described using the timing chart of FIG. 6.

The high-speed clock input CLK is inputted sequentially. The 1:2 frequency divider 31a divides it by adding a delay of ΔTb0 to generate a 1/2 CLK. The divided clock-signal (1/2 CLK) is supplied to the multiplexer block 11a via the clock buffer 21a. A delay of ΔTb1 is newly added. The multiplexer block 11a outputs data SGI1 by a delay of ΔTb2.

The clock CLK rises and the input signal to the delayed flip-flop 14 via the delay of ΔTb0+ΔTb1+ΔTb2 is outputted from the multiplexer block 11a.

It is considered that a clock signal CLK1 of the delayed flip-flop 14 is supplied via the clock buffer 20 with a designed delay-time to produce the delay of ΔTa1 from the high-speed clock input. When the delay time Δ Ta1 of the clock buffer 20 with a designed delay-time is adjusted so as to satisfy the following equation (3), as shown in FIG. 6, the timings of the data SIG1 switching and the fall edge in the clock CLK1 are matched.

ΔTb0+ΔTb1+ΔTb2=ΔTa1 (3)

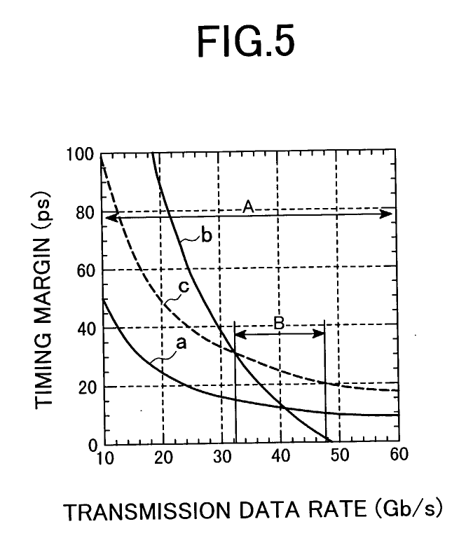

The fall edge in the clock CLK1 is located at 1/2 of the signal period of the data SIG1 (data BO in FIG. 6). As described above, the delayed flip-flop 14 is synchronized with the fall edge in the clock CLK1 to sample data. The timing margin Tm between the data and the clock signal is T/2. When T is changed, that is, the data transmission speed is changed, this means that the fall edge in the clock CLK1 is located at 1/2 of the signal period of the data SIG1. Data can be latched at ideal timing without depending on the data transmission speed. FIG. 5 shows the effect in comparison with the prior art.

Focusing on the characteristic obtained when introducing the multiplexer of the present invention, in the range A of data transmission speeds of 10 to 60 Gb/s, the timing margin of T/2 as half of any period T is obtained. The prior art adjusted so as to provide the timing margin of T/2 at a data transmission speed of 40 Gb/s is in the operating range B from 32 to 48 Gb/s. The multiplexer of the present invention can obtain the preferable timing margin at wide data transmission speed.

Focusing on the timing margin Tm of the delayed flip-flop 14, the timing margin in the multiplexer block 11a shown in FIG. 1 can obtain the same effect. In this case, the delay time of the clock buffer 21a is set to the sum of a delay time ΔTc0 of the 1:2 frequency divider 31b, a delay time ΔTc1 of the clock buffer 21b, and a delay Δ Tc2 or ΔTc3 from the clock input (1/4 CLK1) of the multiplexer block 11b or 11c to the output of parallel data ODD or EVEN. When the data output of the 1:2 frequency divider 31b is the rise edge in the clock (1/2 CLK), the input data decision of the multiplexer block 11a is set to the fall edge in the clock (1/2 CLK1). When the data output of the 1:2 frequency divider 31b is the rise edge in the clock (1/2 CLK), the input data decision of the multiplexer block ha is set to the rise edge in the clock (1/2 CLK1). Timing margin Tm1 in the multiplexer block 11a can be T/2. The T indicates a data one-period of the ODD or EVEN.

From the above description, it is apparent that at any stage of the multiplexer having n stages, the timing margin Tm in the delayed flip-flop or the multiplexer block can be set to an optimal value to the data period T.

Introduction of the present invention into timing design at any stage is arbitrary when necessary.

In the first embodiment of the optical transmitter according to the present invention, in the multiplexer as one of the components of the optical transmitter, the delay of the clock buffer with a designed delay-time or the clock buffer arranged in the clock path of the delayed flip-flop or the multiplexer block is set to be equal to the sum of a delay of the previous stage 1:2 frequency divider, a delay of the clock buffer and a delay from the clock input to the data output of the multiplexer block. The clock trigger of the 1:2 frequency divider and the clock trigger of the multiplexer block are shifted by a clock half period. In the delayed flip-flop or the multiplexer block, when the data one-period is T, the timing margin can be set to T/2.

The effect can realize the optical transmitter which can be operated irrespective of the data transmission speed.

<Embodiment 2>

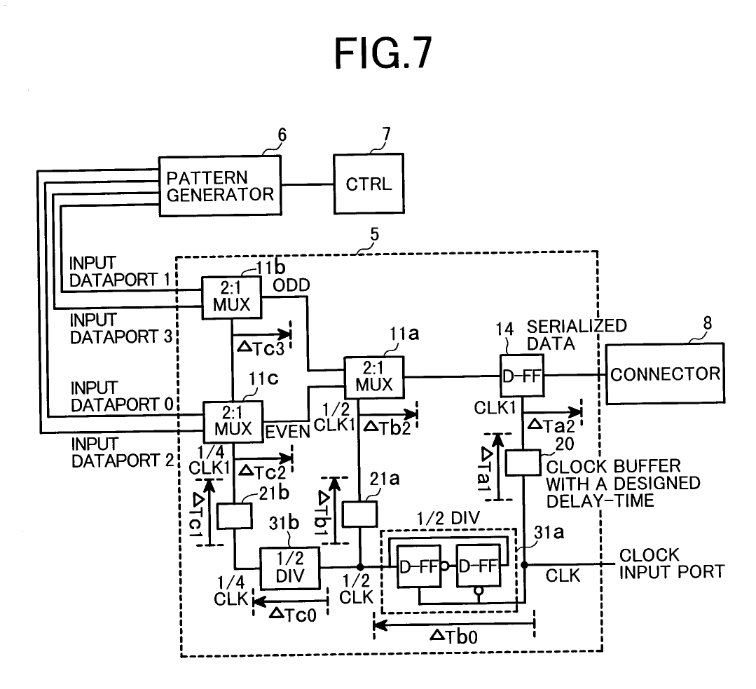

FIG. 7 is a circuit block diagram of the signal generator using a multiplexer showing a second embodiment of the present invention. A signal generator shown in FIG. 7 has a control circuit 7 controlling the characteristic of a signal generated; a pattern generator 6 in which the control signal from the control circuit 7 controls the signal pattern of the signal outputs of a plurality of parallel data 0-3 and the clock frequency; a multiplexer 5 to which four parallel data 0-3 and clocks are inputted multiplexing the parallel data to serial data; and at least one connector 8 for applying the output of the multiplexer 5 to an arbitrary device.

The multiplexer 5 is divided into the first to the third stages. The first stage has two multiplexer blocks 11b, 11c multiplexing the four parallel data 0-3 to two parallel data; a clock buffer 21b; and a 1:2 frequency divider 31b superposing frequency division to the input of the high-speed clock CLK to output a 1/4 divided clock-signal.

The second stage has one multiplexer block ha multiplexing the two parallel data of the output of the first stage to one serial data; a clock buffer 21a; and a 1:2 frequency divider 31a dividing the high-speed clock input.

The third stage as the final stage has a delayed flip-flop 14 performing retiming of the serial data of the output of the second stage; and a clock buffer 20 with a designed delay-time supplying the high-speed clock CLK to the delayed flip-flop.

In the block construction, the 1:2 frequency divider 31a changes the output signal, that is, the input signal of the clock buffer 21a at the rise edge in the high-speed clock input CLK. The delayed flip-flop 14 is connected so as to decide and sample data at the fall edge in the clock of the output of the clock buffer 20 with a designed delay-time. A delay ΔTa1 of the clock buffer 20 with a designed delay-time is set to a time from the high-speed clock input to the data output of the multiplexer block 11a, that is, ΔTb0+ΔTb1+ΔTb2.

The effect obtained by providing the above connection and delay requirements is the same as that of the multiplexer 5 according to Embodiment 1 and the multiplexer which can be operated irrespective of the data transmission speed is provided.

The signal generator of this embodiment using the multiplexer can realize the signal generator which can be operated irrespective of the data transmission speed.

In this embodiment, the multiplexer has three stages. Needless to say, it may have n stages. This is the same in the embodiments described below.

<Embodiment 3>

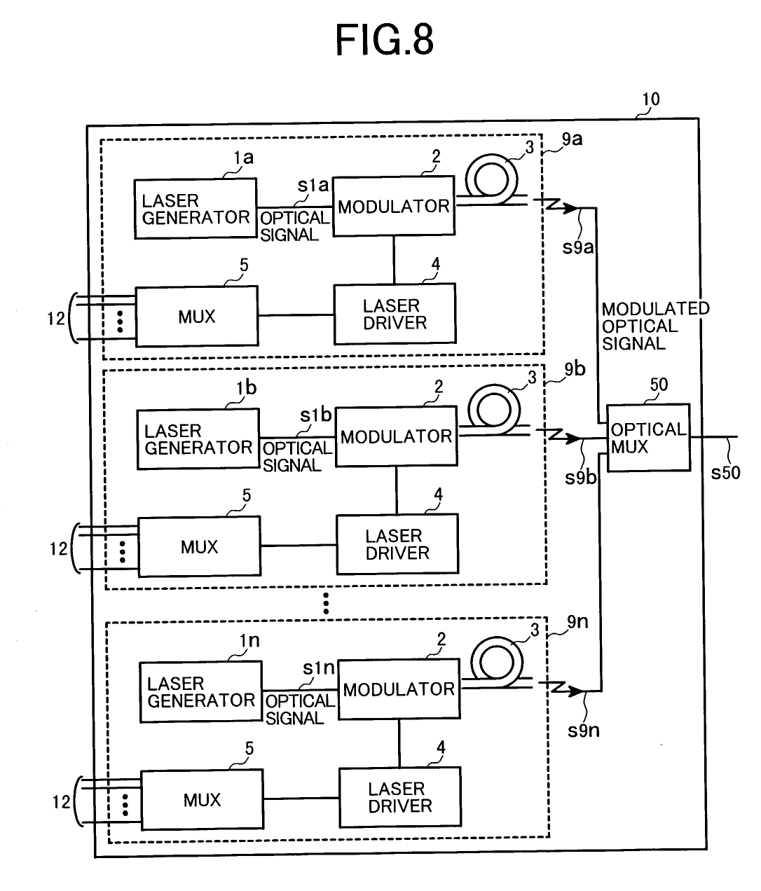

FIG. 8 is a circuit block diagram of another optical transmitter showing a third embodiment of the present invention. In an optical transmitter 10 for wavelength division multiplexing shown in FIG. 8, a plurality of laser generators 1a, 1b, . . . , 1n having different wavelengths are incorporated into optical transmitters 9a, 9b, . . . , 9n. A plurality of obtained modulated optical signals s9a, s9b, . . . , s9n are multiplexed and outputted by an optical multiplexer 50.

In the optical transmitter 10, multiplexers 5 in the optical transmitters 9a, 9b, . . . , 9n receive, as inputs, a plurality of parallel data 12 and multiplex and output serial data. The output signal is amplified by laser drivers 4 to be supplied to laser modulators 2. The modulated optical signals s9a, s9b, . . . , s9n modulating optical signals s1a, s1b, . . . , s1n from the laser generators 1a, 1b, ln are inputted to the optical multiplexer 50 via optical fibers 3 to output an optical signal for wavelength division multiplexing s50. The optical transmitters 9a, 9b, . . . , 9n are provided with the multiplexer 5 which can be operated irrespective of the data transmission speed, as in the multiplexer according to the first embodiment.

According to this embodiment, it is possible to realize an optical transmitter for wavelength division multiplexing which can be operated irrespective of the data transmission speed.

<Embodiment 4>

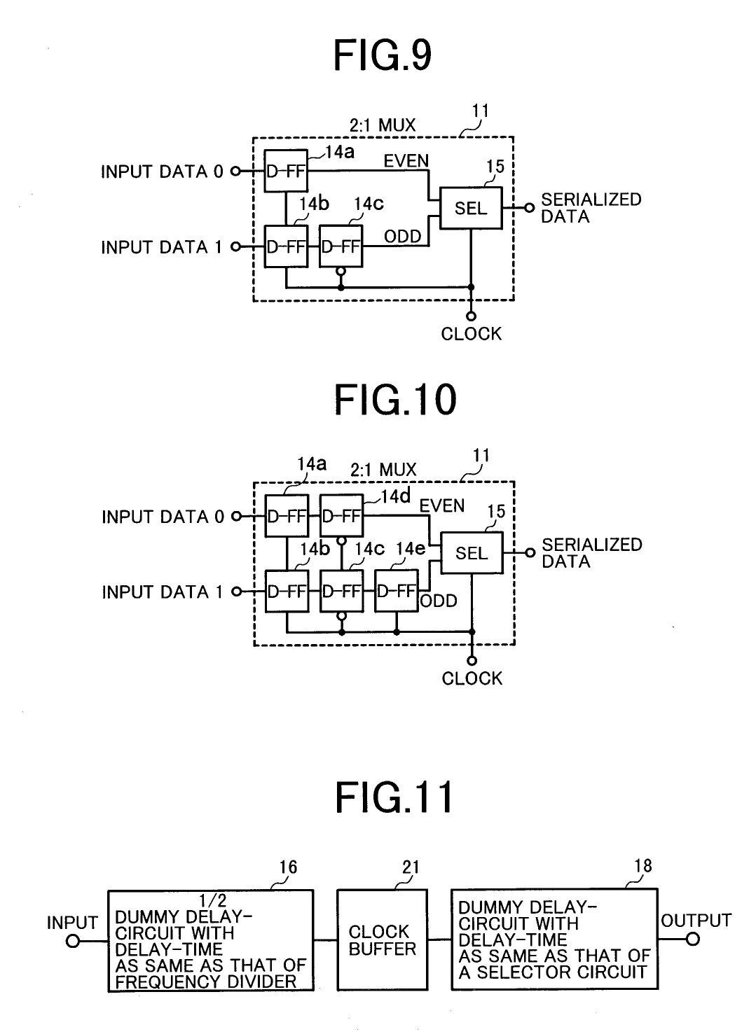

FIG. 9 is a block diagram showing a construction example of multiplexer blocks 11a-11c constructing the multiplexer used in the optical transmitter and the signal generator of the present invention described in Embodiments 1-3.

In FIG. 9, to a multiplexer block 11, two parallel data 0 and 1 are inputted to two delayed flip-flops 14a, 14b operated by the same clock trigger. Only the one delayed flip-flop 14b is connected to a delayed flip-flop 14c operated by a clock trigger of the phase reverse from the above-mentioned clock trigger. Two data of the input of a selector circuit (SEL) 15 are shifted by a clock half period. The selector circuit 15 multiplexes the data by triggering both rise and fall edges in the clock. The data can be selected by a sufficient timing margin in both the EVEN and ODD of the input of the selector circuit.

<Embodiment 5>

FIG. 10 is a block diagram showing another construction example of multiplexer blocks 11a-11c constructing the multiplexer used in the optical transmitter and the signal generator of the present invention described in Embodiments 1-3.

In FIG. 10, to a multiplexer block 11, two parallel data 0 and 1 are inputted to two delayed flip-flops 14a, 14b operated by the same clock trigger. The delayed flip-flops 14a, 14b are connected to delayed flip-flops 14c, 14d operated by a clock trigger of the phase reverse from the above-mentioned clock trigger to construct master-slave type delayed flip-flops.

Only one of the master-slave type delayed flip-flops is connected to a delayed flip-flop 14e operated by a clock trigger of the same phase as the above-mentioned clock trigger. Two data of the input of the selector circuit 15 are shifted by a clock half period. The selector circuit 15 multiplexes the data by triggering both the rise and fall edges in the clock. The data can be selected by a sufficient timing margin in both the EVEN and ODD of the input of selector circuit 15.

In the path of the two parallel data, the master-slave type delayed flip-flops are used. Irrespective of ON/OFF of the clock, the input waveform of the multiplexer block 11 does not appear directly in the input of the selector circuit. Noise of the output waveform of the selector circuit can be reduced.

<Embodiment 6>

FIG. 11 is a block diagram showing a construction example of the clock buffer with a designed delay-time constructing the multiplexer used in the optical transmitter and the signal generator of the present invention described in Embodiments 1-3.

To prevent the influence of the process deviation and the temperature deviation in the timing margin in the delayed flip-flop and the multiplexer block constructing the multiplexer, in FIGS. 1 and 7, there is provided a clock buffer 20 with a designed delay-time having a delay corresponding to the delay from the input end of the 1:2 frequency divider 31a via the clock buffer 21a to the output end of the multiplexer block 11a. The clock buffer 20 with a designed delay-time may be constructed as shown in FIG. 11. It is constructed by connecting in series a dummy delay-circuit with delay-time as same as that of a 1:2 frequency divider 16 dummying the delays; a clock buffer 21; and a dummy delay-circuit with delay-time as same as that of a selector circuit 18.

From such construction, when the delay is increased or decreased by the process deviation during manufacture and the temperature deviation in an operating environment in the circuits, the clock buffer 20 with a designed delay-time can increase or decrease the delay corresponding to it. Optimization of the timing margin can be realized by non-adjustment.

<Embodiment 7>

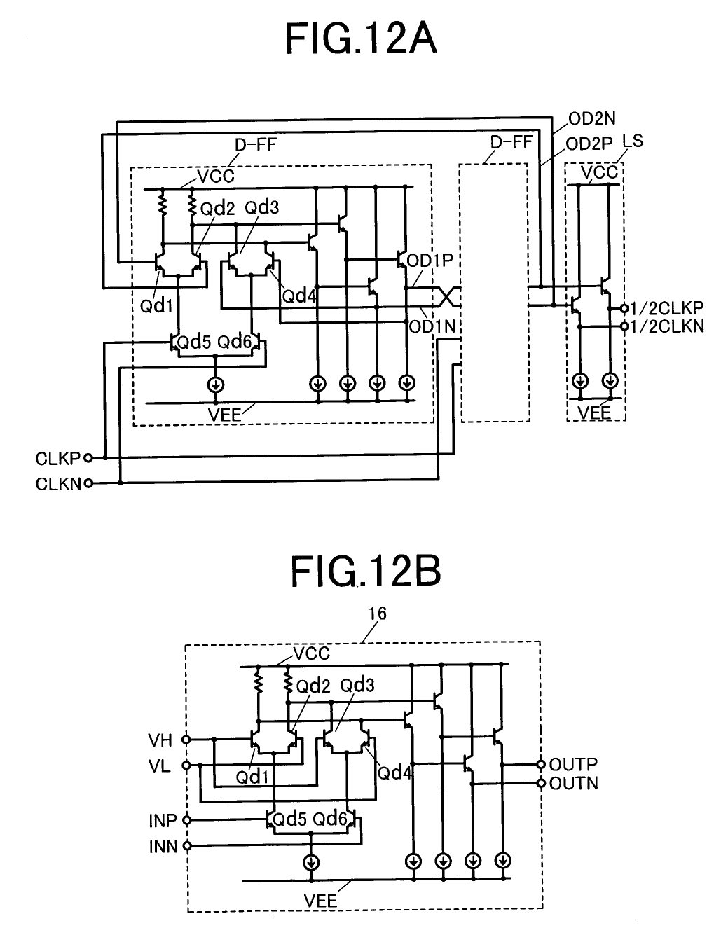

FIG. 12A shows an example of the 1:2 frequency divider and FIG. 12B shows the dummy delay-circuit with delay-time as same as that of a 1:2 frequency divider dummying the delay. The 1:2 frequency divider shown here is constructed by an emitter-coupled-logic (ECL) and is suitable for high-speed operation. The above embodiments show the example in which the clock signal and the data signal are single-phase signals. In an ultra high-speed optical transmitter having a data transmission speed of 10 or 40 Gb/s, a signal differentiating circuit is often used, as shown in FIG. 12A.

The 1:2 frequency divider has two delayed flip-flops (D-FF) and a level shift circuit LS. The D-FF is constructed by circuits connected in series. Of the upper stage pairs having transistors Qd1-Qd4, the transistors Qd1, Qd2 are connected to the outputs of the other D-FF. The transistors Qd3, Qd4 are connected to the outputs (OD1P, OD1N) of the D-FF itself. The level shift circuit LS shifts the potentials of outputs OD2P, OD2N of the D-FF to the potentials suitable for the clock inputs of the next stage frequency divider (not shown, corresponding to clocks CLKP, CLKN of FIG. 12A). The connection relation between the clock signal and the data signal of the two D-FFs is the same as the above embodiments except that the signals are differential.

To dummy the delay of the 1:2 frequency divider, the connection in the D-FF may be changed as shown in FIG. 12B. The bases of the transistors Qd3, Qd4 are separated from the output terminals. The bases of the transistors Qd1, Qd3 and the bases of the transistors Qd2, Qd4 are connected, respectively. The bases are fixed to direct current potentials VH, VL. The direct current potentials VH, VL are set to the high potential and the low potential of the data signal. The delay time from input signals INP, INN to output signals OUTP, OUTN can be almost equal to the delay time from clock signals CLKP, CLKN in the 1:2 frequency divider to outputs 1/2 CLKP, 1/2 CLKN of the frequency divider. In FIGS. 12A and 12B, VCC is a high potential side source voltage and VEE is a low potential side source voltage.

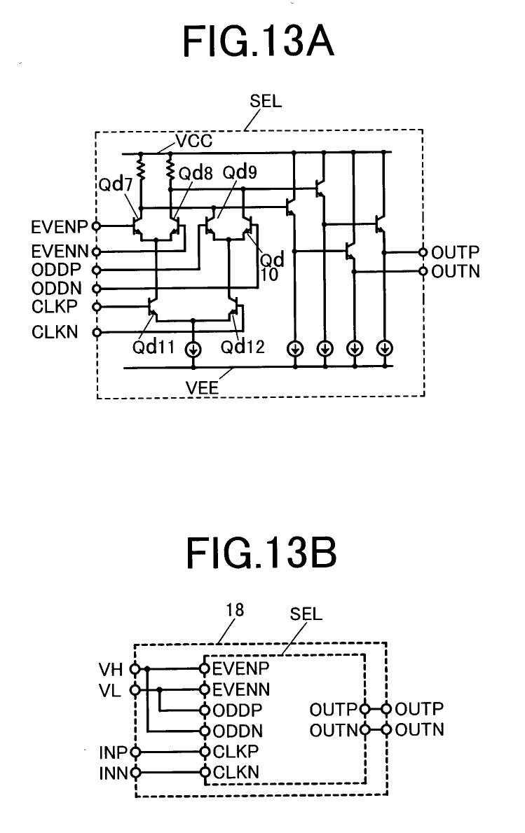

FIG. 13A shows an example of a selector circuit constructed by a differential ECL circuit and FIG. 13B shows a dummy delay-circuit with delay-time as same as that of a selector circuit dummying the delay. The selector circuit SEL is constructed by circuits connected in series. Data signals EVENP, EVENN, ODDP and ODDN are applied to the upper stage differential pairs having transistors Qd7-Qd10. The clock signals CLKP, CLKN are applied to the lower stage differential pair having transistors Qd11, Qd10. Any one of the input signals is outputted to data OUTP, OUTN, which is switched by the clock signal.

To dummy the delay of the selector circuit, the connection of the selector circuit may be changed as shown in FIG. 13B. Data input terminals EVENP, ODDN and data input terminals EVENN, ODDP are connected, respectively. They are fixed to direct current potentials VH, VL. The direct current potentials VH, VL are set to the high potential and the low potential of the data signal. The delay time from input signals INP, INN to output signals OUTP, OUTN can be almost equal to the delay time from clock signals CLKP, CLKN to data output signals OUTP, OUTN in the selector circuit.

The above dummy delay-circuit is used so as to maintain the timing relation between the data signal and the clock signal constant when deviation in the transistor characteristic due to manufacture variation and change in an operating environment change the delay characteristic of the circuit.

The preferred embodiments of the present invention are described above. Needless to say, the present invention is not limited to the above embodiments and various design modifications can be made within the scope without departing from the spirit of the present invention. For example, in Embodiment 7, its element circuit is constructed by a bipolar transistor. Without being limited to this, a FET, a HBT, a HEMT or a MOS-FET may be substituted to obtain the same effect.

Needless to say, the multiplicity of the multiplexer used in the optical transmitter and the signal generator is an arbitrary natural number of 2 or above.

Needless to say, the data and clock transmission type may be of a differential type or a single-phase type to obtain the above effect.

In the present invention, when the data transmission speed is changed, the corresponding clock speed is also changed. For example, the data transmission speed of 40 Gb/s corresponds with a high-speed clock of 40 GHz.

According to the present invention, in the optical transmitter and the signal generator using the multiplexer multiplexing a plurality of parallel data to one serial data, the delay of the clock buffer with a designed delay-time arranged in the clock path of the delayed flip-flop constructing the multiplexer is set to be equal to the sum of a delay of the previous stage 1:2 frequency divider, a delay of the clock buffer and a delay from the clock input to the data output of the multiplexer block. The relation between the clock trigger of the 1:2 frequency divider and the clock trigger of the multiplexer block is shifted by a clock half period. The timing margin of the delayed flip-flop can be set to T/2 of the timing margin as an optimal value. This effect can realize the optical transmitter and the signal generator which can be operated irrespective of the data transmission speed.

What is claimed is:

1. An optical transmitter comprising:
a multiplexer receiving, as inputs, a plurality of parallel data and clock signals and multiplexing said parallel data to serial data;
a laser driver amplifying said serial data;
a laser generator generating an optical signal;
a modulator outputting a modulated optical signal obtained by modulating said optical signal according to the modulation signal of the output of said laser driver; and
an optical fiber transmitting said modulated optical signal,
wherein
said multiplexer has, at the nth stage (n is a natural number of 2 or above) as a final output stage, a clock buffer with a designed delay-time; and a delayed flip-flop receiving, as an input, one serial data from n−1th stage and outputting one serial data synchronized with a clock input via the clock buffer,
said multiplexer has, at the jth stage (j=1, . . . , n−1: j is a natural number), a frequency divider dividing a clock signal inputted to the jth stage; a clock buffer receiving, as an input, a divided clock-signal obtained by the frequency divider; and 2^{n-j-1} multiplexer blocks converting two inputted parallel data into one serial data using the output clock of said clock buffer,
said jth stage 2^{n-j-1} multiplexer blocks are connected so that one serial data outputted from the multiplexer blocks is multiplexed to one serial data in the output of the n−1th stage multiplexer block,
the delay of said nth stage clock buffer with a designed delay-time is set to be the total of delays from the clock input of the n−1th stage frequency divider to the serial data output in said n−1th stage multiplexer block,
a clock signal of an operating reference of said n−1th stage frequency divider and a clock signal in which said nth stage delayed flip flop performs data decision are set to have a half period delay.

2. The optical transmitter according to claim 1, wherein
a delay produced in at least one of the second to jth stage clock buffer circuits is set to be the total of delays from the clock input of the j-1th stage frequency divider to the serial data output in the j-1th stage multiplexer block,
a clock signal of the operating reference of said j-1th stage frequency divider and a clock signal in which the jth-stage multiplexer block performs input data decision are set to have a half period delay.

3. The optical transmitter according to claim 1, wherein said n−1th stage frequency divider changes its output at the rise edge in the clock signal and the nth stage delayed flip flop performs data decision at the fall edge in the clock signal.

4. The optical transmitter according to claim 2, wherein said n−1th stage frequency divider changes its output at the rise edge in the clock signal and the nth stage delayed flip flop performs data decision at the fall edge in the clock signal.

5. The optical transmitter according to claim 1, wherein the delay of said nth stage clock buffer with a designed delay-time is set to be the sum of a delay from the clock input to the divided clock-signal output of the n−1th stage frequency divider, a delay from the input to the output of the n−1th stage clock buffer, and a delay from the clock input to the serial data output in the n−1th stage multiplexer block.

6. The optical transmitter according to claim 5, wherein the delay of said jth stage clock buffer is set to be the sum of a delay from the clock input to the divided clock-signal output of the j-1th stage frequency divider, a delay from the input to the output of the j-1th stage clock buffer, and a delay from the clock input to the serial data output in the j-1th stage multiplexer block.

7. The optical transmitter according to claim 1, wherein
said n−1th stage multiplexer block has a selector circuit selecting and outputting one of two parallel data,
said clock buffer with a designed delay-time is constructed by connecting in series:
a dummy delay-circuit with delay-time as same as that of a 1:2 frequency divider dummying a delay of said frequency divider;
clock buffers equal in circuit construction and in number to those of the clock buffers used at the n−1th stage; and
a dummy delay-circuit with delay-time as same as that of a selector circuit dummying a delay of said selector circuit.

8. The optical transmitter according to claim 2, wherein
said n−1th stage multiplexer block has a selector circuit selecting and outputting one of two parallel data,
said clock buffer with a designed delay-time is constructed by connecting in series:
a dummy delay-circuit with delay-time as same as that of a 1:2 frequency divider dummying a delay of said frequency divider;
clock buffers equal in circuit construction and in number to those of the clock buffers used at the n−1th stage; and
a dummy delay-circuit with delay-time as same as that of a selector circuit dummying a delay of said selector circuit.

9. The optical transmitter according to claim 3, wherein
said n−1th stage multiplexer block has a selector circuit selecting and outputting one of two parallel data,
said clock buffer with a designed delay-time is constructed by connecting in series:
a dummy delay-circuit with delay-time as same as that of a 1:2 frequency divider dummying a delay of said frequency divider;
clock buffers equal in circuit construction and in number to those of the clock buffers used at the n−1th stage; and
a dummy delay-circuit with delay-time as same as that of a selector circuit dummying a delay of said selector circuit.

10. The optical transmitter according to claim 4, wherein
said n−1th stage multiplexer block has a selector circuit selecting and outputting one of two parallel data,
said clock buffer with a designed delay-time is constructed by connecting in series:
a dummy delay-circuit with delay-time as same as that of a 1:2 frequency divider dummying a delay of said frequency divider;
clock buffers equal in circuit construction and in number to those of the clock buffers used at the n−1th stage; and
a dummy delay-circuit with delay-time as same as that of a selector circuit dummying a delay of said selector circuit.

11. The optical transmitter according to claim 5, wherein
said n−1th stage multiplexer block has a selector circuit selecting and outputting one of two parallel data,
said clock buffer with a designed delay-time is constructed by connecting in series:
a dummy delay-circuit with delay-time as same as that of a 1:2 frequency divider dummying a delay of said frequency divider;
clock buffers equal in circuit construction and in number to those of the clock buffers used at the n−1th stage; and
a dummy delay-circuit with delay-time as same as that of a selector circuit dummying a delay of said selector circuit.

12. The optical transmitter according to claim 6, wherein
said n−1th stage multiplexer block has a selector circuit selecting and outputting one of two parallel data,
said clock buffer with a designed delay-time is constructed by connecting in series:
a dummy delay-circuit with delay-time as same as that of a 1:2 frequency divider dummying a delay of said frequency divider;
clock buffers equal in circuit construction and in number to those of the clock buffers used at the n−1th stage; and
a dummy delay-circuit with delay-time as same as that of a selector circuit dummying a delay of said selector circuit.

13. A signal generator comprising:
a control circuit controlling the characteristic of a signal generated;
a pattern generator in which the control signal from the control circuit controls the signal pattern of the signal outputs of a plurality of parallel data and the clock frequency;
a multiplexer receiving, as inputs, a plurality of parallel data and clocks and multiplexing said parallel data to serial data; and
at least one connector for applying the output of the multiplexer to a predetermined device,
wherein
said multiplexer has, at the nth stage (n is a natural number of 2 or above) as a final output stage, a clock buffer with a designed delay-time; and a delayed flip-flop receiving, as an input, one serial data from n−1th stage and outputting one serial data synchronized with a clock input via the clock buffer,
said multiplexer has, at the jth stage (j=1, . . . , n−1: j is a natural number), a frequency divider dividing a clock signal inputted to the jth stage; a clock buffer receiving, as an input, a divided clock-signal obtained by the frequency divider; and 2^{n-j-1} multiplexer blocks converting two inputted parallel data into one serial data using the output clock of said clock buffer,
said jth stage 2^{n-j-1} multiplexer blocks are connected so that each serial data outputted from the multiplexer blocks is multiplexed to one serial data in the output of the n−1th stage multiplexer block,
the delay of said nth stage clock buffer with a designed delay-time is set to be the total of delays from the clock input of the n−1th stage frequency divider to the serial data output in said n−1th stage multiplexer block,
a clock signal of an operating reference of said n−1th stage frequency divider and a clock signal in which said nth stage delayed flip flop performs data decision are set to have a half period delay.

14. The signal generator according to claim 13, wherein
a delay produced in at least one of the second to jth stage clock buffer circuits is set to be the total of delays from the clock input of the j-1th stage frequency divider to the serial data output in the j-1th stage multiplexer block,
a clock signal of the operating reference of said j-1th stage frequency divider and a clock signal in which the jth-stage multiplexer block performs input data decision are set to have a half period delay.

15. The signal generator according to claim 13, wherein said n−1th stage frequency divider changes its output at the rise edge in the clock signal and the nth stage delayed flip flop performs data decision at the fall edge in the clock signal.

16. The signal generator according to claim 14, wherein said n−1th stage frequency divider changes its output at the rise edge in the clock signal and the nth stage delayed flip flop performs data decision at the fall edge in the clock signal.

17. The signal generator according to claim 13, wherein the delay of said nth stage clock buffer with a designed delay-time is set to be the sum of a delay from the clock input to the divided clock-signal output of the n−1th stage frequency divider, a delay from the input to the output of the n−1th stage clock buffer, and a delay from the clock input to the serial data output in the n−1th stage multiplexer block.
